(19) United States
(12) Patent Application Publication
(10) Pub. No.: US 2014/0025493 A1
(43) Pub. Date: Jan. 23, 2014

(54) CUSTOM RETARGETING DESCRIPTION LANGUAGE

(71) Applicants: Vinod Balakrishnan, Fremont, CA (US); Prakash Chockalingam, San Jose, CA (US); Amlan Haldar, Santa Clara, CA (US); Dave Morro, Santa Clara, CA (US)

(72) Inventors: Vinod Balakrishnan, Fremont, CA (US); Prakash Chockalingam, San Jose, CA (US); Amlan Haldar, Santa Clara, CA (US); Dave Morro, Santa Clara, CA (US)

(73) Assignee: YAHOO! INC., SUNNYVALE, CA (US)

(21) Appl. No.: 13/555,018

(22) Filed: Jul. 20, 2012

(51) Int. Cl. G06Q 30/02

(52) U.S. Cl. 705/14.53

(57) ABSTRACT

A system and method for re-targeting users includes: logging user activity within a network of users; categorizing parameters of the user activity; storing the categorized parameters; receiving a request for re-targeting; reformulating the request using a custom language definition; and running the re-formulated request against the stored categorized parameters to generate a list of users matching the request.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of on-line advertising, and more particularly relates to the field of advertisement re-targeting.

### BACKGROUND OF THE INVENTION

On-line sites such as Yahoo! collect enormous amounts of data on user activity but currently have limited ways to combine this data to create arbitrary sets of users for advertisement (ad) re-targeting.

### SUMMARY OF THE INVENTION

Briefly, according to an embodiment of the invention a method for re-targeting users includes steps or acts of: logging user activity within a network of users; categorizing parameters of the user activity; storing the categorized parameters; receiving a request for re-targeting; reformulating the request using a custom language definition; and running the re-formulated request against the stored categorized parameters to generate a list of users matching the request.

According to another embodiment of the invention, a system for re-targeting users includes: a memory with computer-executable instructions stored therein, and a processor device operably coupled with the memory. The computer-executable instructions include the method steps above.

According to another embodiment of the present invention, a non-transitory computer readable storage medium has computer-executable instructions stored therein. The computer-executable instructions include the method steps above.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is an example of a re-targeting description in JSON, according to an embodiment of the present invention;

FIG. 2 is a flowchart of a method according to an embodiment of the invention;

FIG. 3 is a high level represents of the components configured to operate according to showing an information processing system configured to operate according to an embodiment of the present invention; and

FIG. 4 is a high level block diagram of a computer processing device configured to operate according to embodiments of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe a domain specific language capability that allows advertisers/account managers to generate targeted sets of users based on their activities on Internet sites such as Yahoo!. This language solves the problem of how to re-target users that are active within a network such as Yahoo! based on their previous activities. An advantage of this method is a formalization of the problem of custom retargeting allowing advertisers to define arbitrary set of users based on their activities. Some examples are: target users who have seen a page view on topics {sports, nfl} at least three times in the last three days. A more complex example would be: target users who have seen a (page view in content topic {sports,nfl} && type !=blog) at least three times in the last three days and who have received a mail from amazon.com domain followed by a purchase of a football-related item in the past 30 days.

According to an embodiment of the present invention, the language is based on the following basic building blocks in the system:

A) Feature type: this represents the ‘kind’ of events/data that we use for targeting. Ex: Mail, Page view, ad clicks, social profiles, etc.

B) Feature attributes: this represents the attributes associated with a feature; for example a mail event has attributes: sender domain, purchase category. A page view event has an attribute of content topic

C) Feature Definition: Boolean expression over Feature attributes for one feature type, ex. page view in content topic {sports} AND content type !=blog

D) Feature definition time period: activity should have occurred within the span of time measured by current time - time of event occurrence.

E) Feature definition frequency: number of times feature occurred.

F) Segment Definition (rule): Boolean expression of sub-segments, ex, (page view in content topic {sports} AND content type !=blog) with recency=3, frequency=4 AND (cmm.domain=amazon.com & cmm.type=purchase) with recency=40, frequency=2

An example of the language is: (pv.ct in {sports,nfl} & pv.type !=blog) with freq=3, rec=3 AND (cmm. dom=amazon.com & cmm.type=purchase) with freq=1,rec=2.

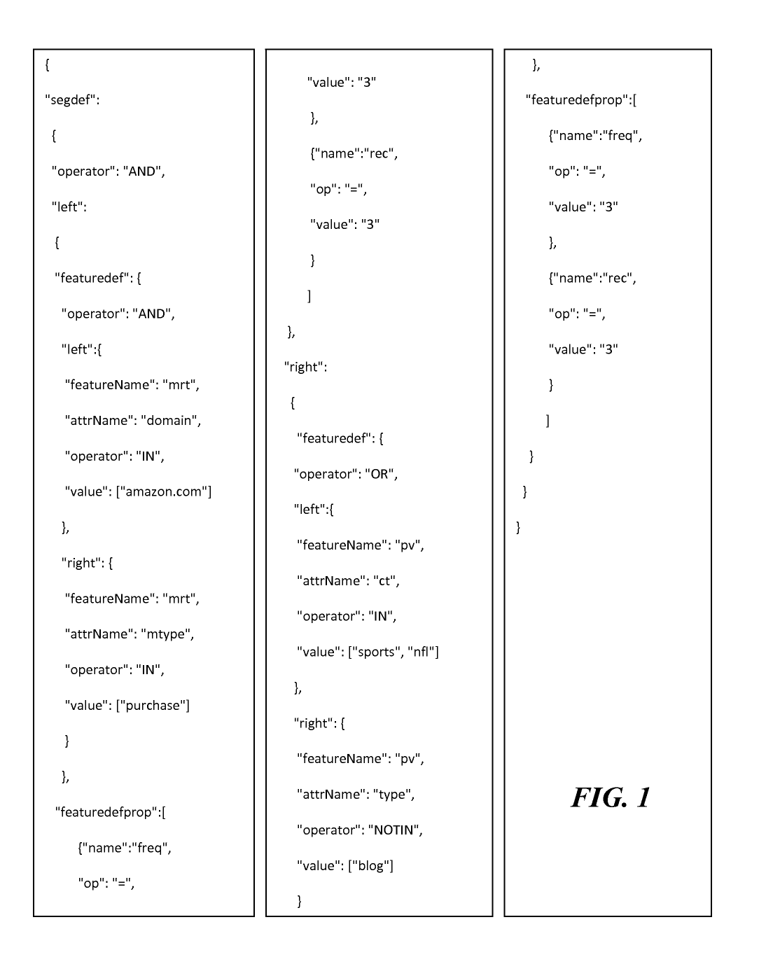

As long as the problem statement for describing a set of users can be expressed in terms of feature definition, feature definition recency, frequency and segment definition, this language can be used. Another implementation of the above language can be done using JSON (JavaScript Object Notation). The language description in JSON is provided in FIG. 1.

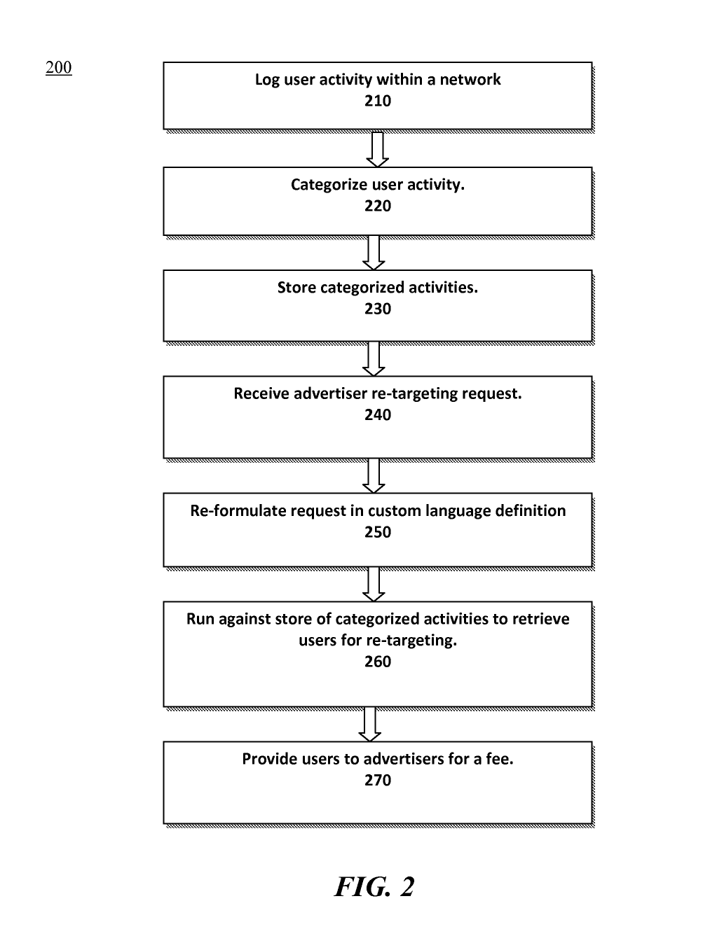

Referring now to FIG. 2, we show a high-level flowchart 200 of a method for customized re-targeting, according to an embodiment of the present invention. First in step 210 we log user activity for all users of a designated on-line site. Next in step 220 we categorize the user activity into pre-selected categories that correspond to the feature attributes. The categories are arranged in a hierarchy of feature attributes within feature types. In step 230 we store the categorized activities associated with the users.

In step 240 we receive a re-targeting request from an advertiser. The request may be along the lines of “provide all users who have clicked on an ad related to entertainment at least twice within the last thirty days.” The request may be in the form of a query using known query languages. In step 250, after parsing the request, we re-formulate the request in the custom re-targeting language definition, according to the invention. The request may appear like this after re-formulating: (ac.ct in {ent}& ac.type !=blog) with freq>=2, rec=30.

In step 260 we run the re-formulated query against the store of categorized user activities to retrieve the users that match the request parameters (clicked on entertainment ad twice within last 30 days). Processing is preferably performed using Java-based technologies, although other similar technologies now known or subsequently developed may be used for the processing of the query. In step 270 we provide the extracted users matching the query to the advertisers. We can provide the service as a subscription service, for example, for a monthly fee, or on an individual, per search basis.

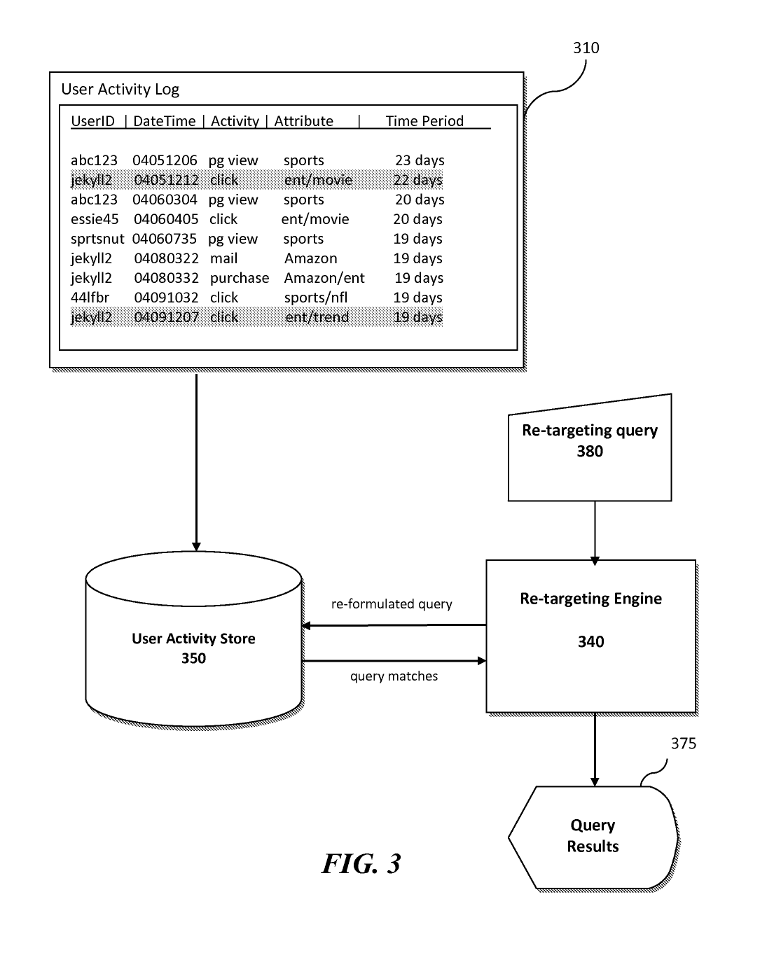

Referring now to FIG. 3 there is shown a simplified depiction of a user activity log 310, a user activity store 350, and the re-targeting engine 340. The user activity log 310 logs activity for all users within a specified network (for example, all Yahoo! users). Some of the data that is logged for every user includes: the user's name or other identification (login name, email address, IP address); the timestamp of the activity; the activity (user click, page view, mail send/receive, purchase); the activity attribute such as the content of the page view or click, the destination of the mail; and the time period counting the time period of current time minus the activity time (how many days since the activity occurred).

Using the example from FIG. 2, the re-targeting engine 340 receives a re-targeting query request 380 from an advertiser. The advertiser requires a list of all users within the network who have clicked on an entertainment-related ad at least twice within the last thirty (30) days. The Re-targeting engine 340 reformulates the query and runs it against the user activity store 350 (a data store holding the categorized user log data). From the activity store 350 we know that the user with userID “jekyl12” matches this request because this user has clicked on an ad related to entertainment twice within the last 30 days. The engine 340 outputs the list 375 of users matching the query.

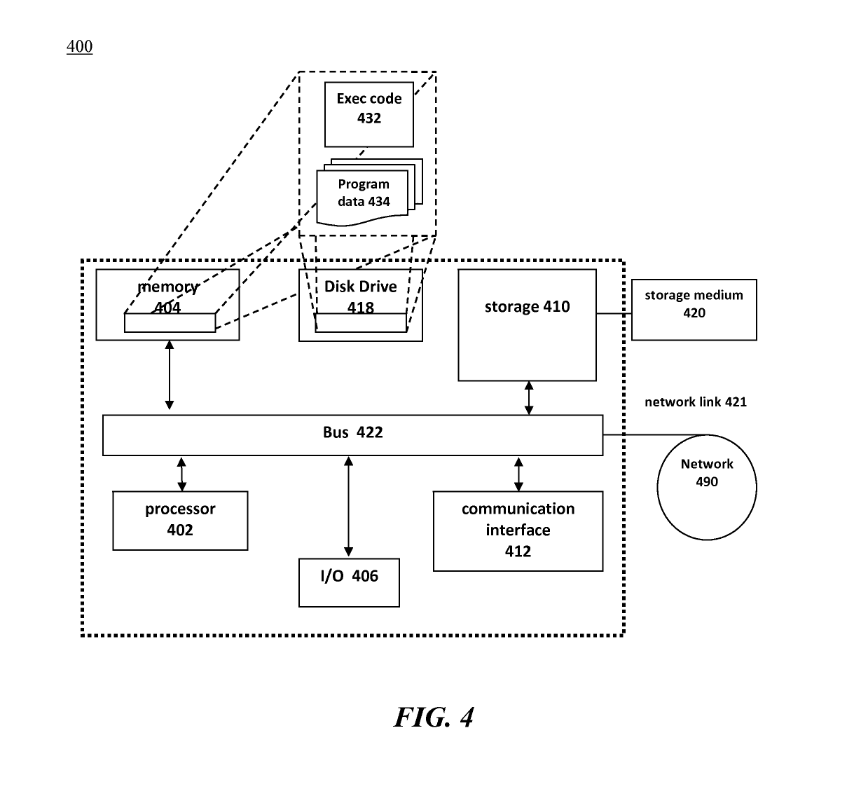

FIG. 4—Hardware Embodiment.

Referring now in specific detail to FIG. 4, there is provided a simplified high-level block diagram of an information processing system 400 for implementing re-targeting in which the present invention may be implemented. For purposes of this invention, computer system 400 may represent any type of device that has the capability to store digital information, such as a computer, information processing system or other programmable electronic device, including a client computer, a server computer, a portable computer, a tablet computer, an embedded controller, a personal digital assistant, Internet TV, the Cloud, and so on. The computer system 400 may be a stand-alone device or networked into a larger system. Computer system 400, illustrated for exemplary purposes as a networked computing device, is in communication with other networked computing devices (not shown) via network 490 and with databases such as User Activity Store 350. As will be appreciated by those of ordinary skill in the art, network 490 may be embodied using conventional networking technologies and may include one or more of the following: local area networks, wide area networks, intranets, public Internet, Cloud Computing and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 400, for simplicity. As will be appreciated by those of ordinary skill in the art, aspects of the invention may be distributed among one or more networked computing devices which interact with computer system 400 via one or more data networks such as, for example, network 490. However, for ease of understanding, aspects of the invention have been described as embodied in a single computing device—computer system 400.

Computer system 400 includes processing device 402 which communicates with an input/output subsystem 406, memory 404, storage 410 and network 490. The processor device 402 is operably coupled with a communication infrastructure 422 (e.g., a communications bus, cross-over bar, or network). The processor device 402 may be a general or special purpose microprocessor operating under control of computer program instructions 432 executed from memory 404 on program data 434. The processor 402 may include a number of special purpose sub-processors such as a query re-formulator, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 404 may be partitioned or otherwise mapped to reflect the boundaries of the various memory subcomponents. Memory 404 may include both volatile and persistent memory for the storage of: operational instructions 432 for execution by processor device 402, data registers, application storage and the like. Memory 404 may include a combination of random access memory (RAM), read only memory (ROM) and persistent memory such as that provided by a hard disk drive 418. The computer instructions/applications that are stored in memory 404, such as instructions for implementing the steps of FIG. 2, are executed by processor 402. The computer instructions/applications 432 and program data 434 can also be stored in hard disk drive 418 for execution by processor device 402.

Those skilled in the art will appreciate that the functionality implemented within the blocks illustrated in the diagram may be implemented as separate components or the functionality of several or all of the blocks may be implemented within a single component. The I/O subsystem 406 may comprise various end user interfaces such as a display, a keyboard, and a mouse. The I/O subsystem 406 may further comprise a connection to a network 490 such as a local-area network (LAN) or wide-area network (WAN) such as the Internet.

The computer system 400 may also include storage 410, representing a magnetic tape drive, an optical disk drive, a CD-ROM drive, and the like. The storage drive 410, which can be removable, reads from and/or writes to a removable storage unit 420 in a manner well known to those having ordinary skill in the art. Removable storage unit 420, represents a compact disc, magnetic tape, optical disk, CD-ROM, DVD-ROM, etc. which is read by and written to by removable storage drive 410. As will be appreciated, the removable storage unit 420 includes a non-transitory computer readable medium having stored therein computer software and/or data for implementing the real-time feedback collection system.

The computer system 400 may also include a communications interface 412. Communications interface 412 allows software and data to be transferred between the computer system and external devices. Examples of communications interface 412 may include a modem, a network interface (such as an Ethernet card), a communications port, a PCMCIA slot and card, etc. Software and data transferred via communications interface 412 are in the form of signals which may be, for example, electronic, electromagnetic, optical, or other signals capable of being received by communications interface 412.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for re-targeting users, comprising:
using a processor device, performing steps of:
logging user activity within a network of users;
categorizing parameters of the user activity;
storing the categorized parameters;
receiving a request for re-targeting;
reformulating the request using a custom language definition; and
running the reformulated request against the stored categorized parameters to generate a list of users matching the request.

2. The method of claim 1 further comprising:
outputting the list of users.

3. The method of claim 2 further comprising monetizing said method by billing an advertiser on a per request basis.

4. The method of claim 2 further comprising monetizing said method by billing on a subscription basis.

5. The method of claim 1 wherein categorizing the parameters comprises arranging the parameters into pre-selected categories corresponding to feature attributes in a hierarchy of feature attributes within feature types.

6. An information processing system for re-targeting users, comprising:
a memory with computer-executable instructions stored therein, said computer-executable instructions, when executed by a processor device, cause a computer to perform steps of:
logging user activity within a network of users;
categorizing parameters of the user activity;
storing the categorized parameters;
receiving a request for re-targeting;
reformulating the request using a custom language definition; and
running the reformulated request against the stored categorized parameters to generate a list of users matching the request; and
the processor device operably coupled with the memory.

7. The information processing system of claim 6 wherein the steps are performed using JavaScript Object Notation language.

8. The information processing system of claim 6 wherein the computer-executable instructions further comprise:
outputting the list of users.

9. The information processing system of claim 8 wherein the computer-executable instructions further comprise:
monetizing by billing an advertiser a per request basis.

10. The information processing system of claim 8 wherein the computer-executable instructions further comprise:
monetizing by billing an advertiser on a subscription basis.

11. The information processing system of claim 8 wherein categorizing the parameters comprises arranging the parameters into pre-selected categories corresponding to feature attributes in a hierarchy of feature attributes within feature types.

12. A computer program product comprising a computer-readable storage medium with computer-executable instructions stored therein, said computer-executable instructions, when executed by a processor device, cause a computer to perform steps of:
logging user activity within a network of users;
categorizing parameters of the user activity;
storing the categorized parameters;
receiving a request for re-targeting;
reformulating the request using a custom language definition; and
running the reformulated request against the stored categorized parameters to generate a list of users matching the request.

13. The computer program product of claim 12 wherein the steps are performed using JavaScript Object Notation Language.

14. The computer program product of claim 12 wherein the computer-executable instructions further comprise:
outputting the list of users.

15. The computer program product of claim 12 wherein the computer-executable instructions further comprise:
monetizing by billing an advertiser a per request basis.

16. The computer program product of claim 12 wherein the computer-executable instructions further comprise:
monetizing by billing an advertiser on a subscription basis.

17. The computer program product of claim 12 wherein categorizing the parameters comprises arranging the parameters into pre-selected categories corresponding to feature attributes in a hierarchy of feature attributes within feature types
